(19) United States
(12) Patent Application Publication
(10) Pub. No.: US 2020/0124012 A1
(43) Pub. Date: Apr. 23, 2020

(54) METHOD AND SYSTEM FOR CONTROLLING IDLE STOP AND GO

(71) Applicants: Hyundai Motor Company, Seoul (KR); Kia Motors Corporation, Seoul (KR)

(72) Inventors: Jason Hoon Lee, Ann Arbor, MI (US); Sejun Kim, Ann Arbor, MI (US); Byungho Lee, Ann Arbor, MI (US); Jaihyun Lee, Ypsilanti, MI (US); Kwangwoo Jeong, Ann Arbor, MI (US)

(21) Appl. No.: 16/165,974

(22) Filed: Oct. 19, 2018

(51) Int. Cl. F02N 11/08; B60W 30/18; B60W 10/06; G06K 9/00

(52) U.S. Cl. CPC F02N 11/0837; B60W 30/18018; G06K 9/00818; F02N 11/0822; B60W 10/06

(57) ABSTRACT

A method for controlling an ISG system is provided. The method includes obtaining a current vehicle location and determining whether the current vehicle location is within a predetermined distance from a preset location or a traffic sign. When the current vehicle location is within the predetermined distance from the preset location or the traffic sign, an ISG mode of the ISG system is automatically inhibited.

### BACKGROUND

### Technical Field of the Disclosure

The present disclosure relates to a method and system for controlling vehicle engine idle stop and go, and more particularly, to a method and system that automatically control vehicle idle stop and go based on a vehicle location and traffic sign information.

### Description of the Related Art

Today, engine idle stop and go (ISG) systems are used to improve fuel consumption by stopping or disabling the engine of a vehicle based on current vehicle speed. For example, an ISG system turns off the vehicle engine when the vehicle speed is decreased to 0 and the brake pedal is engaged. Once the brake pedal is disengaged and an accelerator pedal is engaged, the engine is typically restarted.

However, the currently developed ISG systems do not consider various driving situations when determining whether to disable the engine as they are limited to the conditions described above. Accordingly, a driver is required to manually disable the ISG system (e.g., by manipulating an ISG button) and is also required to manually turn the ISG system back on when the ISG function is desired. That is, these systems do not automatically disable an ISG system based on a current driving situation. A further technology has been developed that provides predefined situations of when to disable an ISG system including a service area or a body of water as an area where the engine should remain on. However, such systems do not automatically detect an area where the ISG area should be disabled, are limited to specific types of service and emergency locations, and require user input.

The above information disclosed in this section is merely for enhancement of understanding of the background of the disclosure and therefore it may contain information that does not form the prior art that is already known in this country to a person of ordinary skill in the art.

### SUMMARY

The present disclosure provides a method and system that control an idle stop and go (ISG) system within a vehicle. The ISG system within a vehicle is capable of disabling an engine within the vehicle to reduce fuel consumption.

According to one aspect of the present disclosure a method of controlling an idle stop and go system of a vehicle may include obtaining a current vehicle location and determining whether the current vehicle location is within a predetermined distance from a preset location or a traffic sign. When the current vehicle location is determined to be within the predetermined distance from the preset location or the traffic sign, an ISG mode of the ISG system may be automatically inhibited. The determination of whether the current vehicle location is within the predetermined distance from the preset location or the traffic sign may be triggered based on engagement of a brake pedal. Additionally, in response to determining that the current vehicle location is beyond the predetermined distance from the preset location, whether the current vehicle location is at a pre-detected ISG suspension location may be determined. In response to determining that the current vehicle location is at the pre-detected ISG suspension location, the ISG mode may be automatically inhibited.

Further, the method may include continuously monitoring a surrounding of the vehicle to detect a traffic sign which may be a stop sign, a yield sign, a pedestrian crossing sign, or the like. In an exemplary embodiment, the current vehicle location, the preset location, and the traffic sign may be determined using an advanced driver assistance system. The traffic sign may be detected using a camera (of the ADAS) mounted on the vehicle. The preset location may be a location stored in a navigation system and may be a home location or a garage location. The current vehicle location may be detected using a global positioning system (GPS) of the ADAS.

Particularly, the ISG mode may turn off an engine of the vehicle based on a plurality of conditions. The plurality of conditions may include a vehicle speed being detected as 0, an accelerator input being detected as 0, and a brake pedal being engaged.

According to another aspect of the present disclosure, a vehicle may include an engine mounted within the vehicle and an ISG system programmed to automatically inhibit an ISG mode based on detecting whether a current vehicle location is within a predetermined distance form a preset location or a traffic sign. The vehicle may further include a vehicle speed sensor configured to detect a current speed of the vehicle and an advanced driver assistance system. Additionally, an accelerator pedal of the vehicle may include a sensor configured to detect a current engagement amount of the accelerator pedal and a brake pedal of the vehicle may include a sensor configured to detect an engagement amount of the brake pedal. The advanced driver assistance system may include a GPS configured to detect the current vehicle location and a camera configured to detect the traffic sign. The vehicle may also include an ISG button configured to receive manual input to enable or inhibit the ISG mode of the ISG system.

According to yet another aspect of the present disclosure, a system may be provided for controlling an ISG of a vehicle. The system may include a memory configured to store program instructions and a processor programmed to execute the program instructions. The program instructions when executed may be configured to obtain a current vehicle location and determine whether the current vehicle location is within a predetermined distance from a preset location or a traffic sign. When the current vehicle location is within the predetermined distance from the preset location or the traffic sign, an ISG mode of the ISG system may be automatically inhibited.

Notably, the present disclosure is not limited to the combination of the elements as listed above and may be assembled in any combination of the elements as described herein.

Other aspects of the disclosure are disclosed infra.

### BRIEF DESCRIPTION OF THE DRAWINGS

The above and other objects, features and advantages of the present disclosure will be more apparent from the following detailed description taken in conjunction with the accompanying drawings.

FIG. 1 illustrates a system within an idle stop and go vehicle according to an exemplary embodiment of the present disclosure;

FIG. 2 illustrates a flowchart of a method of controlling vehicle idle stop and go according to an exemplary embodiment of the present disclosure;

FIG. 3 illustrates a graph of vehicle location in relationship with traffic sign points according to an exemplary embodiment of the present disclosure;

FIG. 4 illustrates an example of the ISG suspension based on detecting a stop sign according to an exemplary embodiment of the present disclosure; and

FIG. 5 illustrates a graph of an exemplary test result showing a distance to a stop sign based on vehicle location according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure provides a method and system for controlling an ISG system to automatically inhibit an ISG mode of the ISG system in response to a vehicle location and traffic sign information. Accordingly, fuel consumption may still be reduced while providing an improved responsiveness to situations where it is desired for the engine to remain enabled. For example, the system is capable of maintaining the engine on while the vehicle is at a stop sign or any other area as desired by a driver without requiring manual deactivation and reactivation of the system. Accordingly, fuel consumption is decreased by avoiding the engine from stopping and being restarted in areas where the stop duration is short.

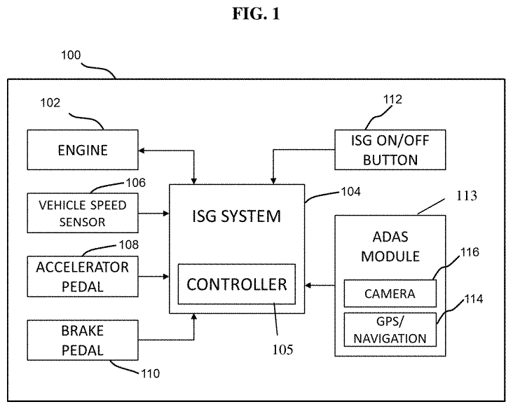

According to an aspect of the present disclosure and as shown in FIG. 1, a vehicle 100 may include an engine 102, a vehicle speed sensor 106, an accelerator pedal 108, a brake pedal 110, and ISG on/off button 112, an ISG system 104, and an advanced driver assistance system (ADAS) 113. In particular, the ISG system 104 may include a controller 105 and the ADAS may include a global positioning system/navigation 114 and a camera 116. The camera may also be a video camera or other similar type of device capable of capturing an image of a surrounding of the vehicle.

The vehicle speed sensor 106 may be configured to detect a current speed of the vehicle 100. The accelerator pedal 108 may include a sensor configured to detect an engagement amount of the accelerator pedal 108 or an input amount at the pedal. In other words, the sensor may be configured to determine the amount of force exerted onto the pedal. Similarly, the brake pedal 110 may include a sensor configured to detect an engagement or input amount of the brake pedal 110. The GPS or navigation 114 may be configured to detect a current position or location of the vehicle. The camera 116 may be configured to capture an image around the vehicle to detect a traffic sign. In addition, the ISG on/off button 112 may be configured to receive a manual input to enable or disable an ISG mode.

Particularly, the vehicle 100 may be in an ISG mode (e.g., mode enabled) in which the ISG system 104 disables the engine 102 to reduce overall fuel consumption in areas where the engine 102 is unnecessary (e.g., at a red light or the like) and also automatically restarts the engine 102 based on particular conditions. When the engine 102 is stopped, a battery (not shown) provides current to loads within the vehicle and while the engine 102 is operating, a starter generator provides the current to the loads. In addition, the ISG mode may be triggered based on a plurality of conditions. For example, the ISG mode is triggered when the vehicle speed is detected by the vehicle speed sensor 106 to be 0, the accelerator pedal 108 is disengaged, and the brake pedal 110 is engaged. Then, when the accelerator pedal 108 is engaged or as the brake pedal 110 is disengaged, the ISG system 104 may be configured to automatically restart the engine 102.

However, to enhance the ISG system 104, the present disclosure provides an improved system and method that inhibit the ISG mode based on a vehicle location and traffic sign. In particular, the ISG mode may be inhibited based on the vehicle being located at a home location or garage and also when a traffic sign is detected to be upcoming in the direction of travel of the vehicle. The method to be described herein below may be executed by a controller having a memory and a processor.

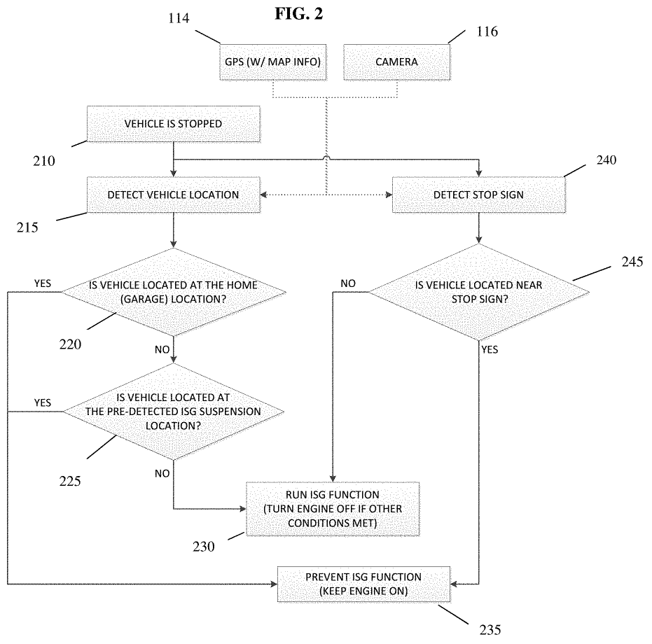

As shown in FIG. 2, the method of controlling the ISG system of a vehicle may include detecting an engagement of a brake pedal 110 to determine whether the vehicle is stopped (210) or about to stop and in response thereto, detecting a current vehicle location (215). In particular, the vehicle location may be detected using the GPS 114. For example, the GPS may also be the navigation system within the vehicle having a map with information regarding the vehicle location. In response to detecting the vehicle location (215), whether the vehicle is within a predetermined distance from a preset location may be determined (220). For example, the method may include determining whether the vehicle is located at a home location or a garage location. Such locations may be preset and stored in a navigation system in communication with the ISG system 104. However, the present disclosure is not limited to such preset locations and may include a parking lot, or any such location pre-stored in the navigation.

When the current vehicle location is beyond the predetermined distance from the preset location, for example, the vehicle is not located near the home location, whether the vehicle is located at a pre-detected ISG suspension location may be detected (225). For example, the system may include previously set locations at which the ISG mode is inhibited. When the vehicle is detected to be at such an inhibition or suspension area, the ISG mode may be automatically inhibited (235). However, when the vehicle is not located at the home location and is not located at the ISG suspension location, the ISG function may be operated (230), that is, the engine may be turned off if a plurality of conditions are also met. Such conditions may include the vehicle speed being detected as 0, the accelerator input being detected as 0, and the brake pedal being engaged (e.g., ISG mode conditions).

When the current vehicle location is determined to be within a predetermined distance (e.g., about 20-30 meters) from the preset location (e.g., home location), the ISG function may be prevented (e.g., the ISG mode may be inhibited) (235) such that the engine is kept on. Similarly, when the current vehicle location is detected to be at a pre-detected ISG suspension location, the ISG mode may be inhibited.

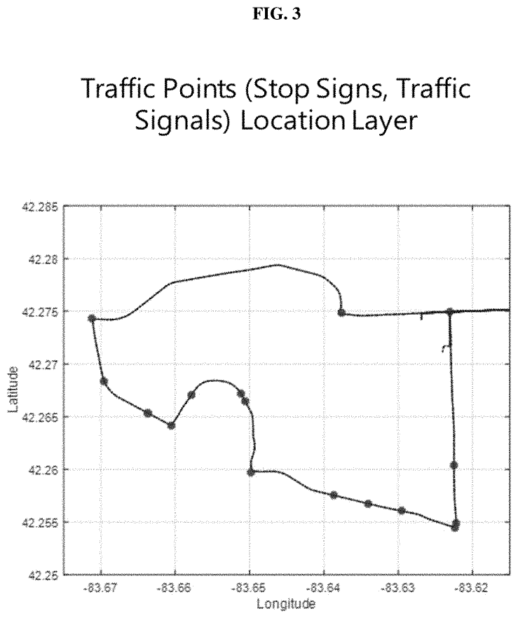

Further, the method may include detecting a traffic sign (240). In particular, a camera 116 may be configured to continuously monitor the surroundings of the vehicle to determine whether a vehicle is approaching a traffic sign. The traffic sign may be a stop sign, a yield sign, a pedestrian crossing sign, or any other traffic sign where the vehicle is stopped for a short period of time. Once the traffic sign is detected (240), the method may include determining whether the current vehicle location is within a predetermined distance from the traffic sign (245) using the GPS. Thus, the GPS and the camera may work in communication with each other. For example, FIG. 3 illustrates a graph showing the latitude and longitude coordinates of a vehicle location and the dots on the graph illustrate traffic points. Such information may be stored within the GPS/navigation system to detect a distance to a detected traffic sign. The GPS may be configured to monitor the distance to the traffic sign which triggers the ISG system.

That is, when the current vehicle location is not within the predetermined distance from the traffic sign, the ISG function may be operated (e.g., engine may be turned off) in consideration of the satisfaction of the ISG mode conditions (e.g., vehicle speed being detected as 0, accelerator input being detected as 0, and brake pedal being engaged). However, when the current vehicle location is within the predetermined distance (e.g., about 20-30 meters) from the traffic sign, the ISG function or mode may be automatically inhibited (235).

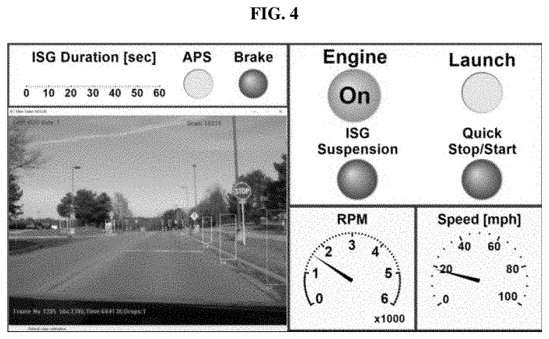

Additionally, FIG. 4 illustrates an ISG system operation in response to detecting a traffic sign. In particular, the figure shows the image captured using the camera 116 in which a stop sign is detected. Based on the distance to the stop sign and the engagement of the brake pedal (shown as a shaded circle), the ISG suspension is inhibited and the engine is maintained in an on state. The figure additionally shows the vehicle speed and the revolutions per minute (rpm) of the engine as well as a duration of the ISG function.

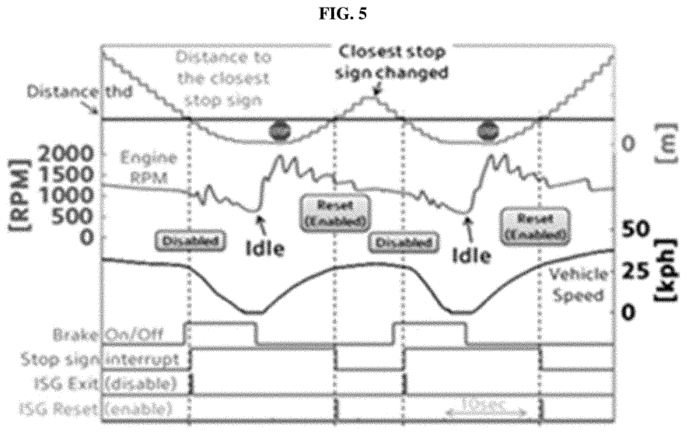

For further explanation, FIG. 5 illustrates a graph of an exemplary test result showing a distance to a stop sign based on vehicle location, vehicle speed, and engagement of a brake pedal. In particular, the graph illustrates an engagement of the brake pedal and a distance threshold (thd). When the distance of the vehicle to the traffic sign is less than the threshold distance, when the brake pedal is engaged, the ISG mode may be disabled and the engine may remain on. The graph further shows that the ISG mode may be reset or enabled again after a predetermined period time or distance after passing the traffic sign. For example, the IS G mode may be reset immediately after the vehicle passes the stop sign. However, the present disclosure is not limited thereto. That is, the ISG mode may be reset about 10 meters after passing the traffic sign to account for inaccuracies in calculating the distance to the traffic sign or the vehicle stopping past the line of a traffic sign. Accordingly, by providing such an ISG inhibition, the fuel consumption is capable of being decreased as the engine is prevented from being turned off during a mere short stop.

According to another exemplary embodiment of the present disclosure, the above-described control of an ISG system may also be applied to user customized inhibition areas. For example, the ISG mode may be suspended when engine stop and restart is not desired or is inappropriate such as before turning the vehicle or during a parking maneuver. Additionally, the information gathered in the present disclosure related to a vehicle location, preset locations, and traffic sign locations may all be received based on a vehicle-to-vehicle communication (V2V) or a vehicle-to-infrastructure (V2I) communication. The method described herein is not limited to the above described vehicle and may also be applied to control an engine stop coasting mode in hybrid vehicles.

As discussed above, the method and system of the present disclosure are capable of automatically controlling an idle stop and go system of a vehicle based on detecting a current vehicle location with respect to a preset location or a traffic sign. Accordingly, the fuel consumption is capable of being improved while still improving user convenience. Thus, unnecessary fuel consumption is prevented while avoiding requiring user manipulation each time an ISG system is to be deactivated by detecting a distance to a traffic sign or a home location. The above-described method and system improve current ISG logics by taking into account driving situations of the vehicle that are not limited to particular types of emergency or service locations or areas of water. Accordingly, a GPS or navigation system may be used to continuously monitor the location of the vehicle during driving and the vehicle may automatically inhibit the ISG mode when the vehicle is detected to be driving within a predetermined distance from a preset location or a traffic sign. An engine is thus prevented from rapid stop and restart when the vehicle is only to be stopped for a short period of time. The prevention of the engine off in these situations prevents unnecessary fuel consumption.

Hereinabove, although the present disclosure is described by specific matters such as concrete components, and the like, the exemplary embodiments, and drawings, they are provided merely for assisting in the entire understanding of the present disclosure. Therefore, the present disclosure is not limited to the exemplary embodiment. Various modifications and changes may be made by those skilled in the art to which the disclosure pertains from this description. Therefore, the spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A method of controlling an idle stop and go (ISG) system of a vehicle, comprising:
obtaining a current vehicle location;
determining whether the current vehicle location is within a predetermined distance from a preset location or a traffic sign; and
automatically inhibiting an ISG mode of the ISG system in response to determining that the current vehicle location is within the predetermined distance from the preset location or the traffic sign.

2. The method of claim 1, wherein the determination of whether the current vehicle location is within the predetermined distance from the preset location or the traffic sign is triggered based on engagement of a brake pedal.

3. The method of claim 1, further comprising:
continuously monitoring a surrounding of the vehicle to detect the traffic sign.

4. The method of claim 1, wherein the preset location is a location stored in a navigation system.

5. The method of claim 4, wherein the preset location is a home location or a garage location.

6. The method of claim 1, wherein the traffic sign is a stop sign, a yield sign, a pedestrian crossing sign, or the like.

7. The method of claim 1, wherein the current vehicle location is detected using a global positioning system.

8. The method of claim 1, wherein the traffic sign is detected using a camera mounted on the vehicle.

9. The method of claim 1, wherein the ISG mode turns off an engine of the vehicle based on a plurality of conditions.

10. The method of claim 9, wherein the conditions include a vehicle speed being detected as 0, an accelerator input being detected as 0, and a brake pedal being engaged.

11. The method of claim 1, wherein the current vehicle location, the preset location, and the traffic sign are determined using an advanced driver assistance system.

12. The method of claim 1, further comprising:
in response to determining the current vehicle location is beyond the predetermined distance from the preset location, determining whether the current vehicle location is at a pre-detected ISG suspension location; and
in response to determining that the current vehicle location is at the pre-detected ISG suspension location, automatically inhibiting the ISG mode.

13. A vehicle, comprising:
an engine mounted within the vehicle; and
an idle stop and go (ISG) system programmed to automatically inhibit an ISG mode based on detecting whether a current vehicle location is within a predetermined distance from a preset location or a traffic sign.

14. The vehicle of claim 13, wherein the ISG mode turns off the engine of the vehicle based on a plurality of conditions.

15. The vehicle of claim 14, wherein the conditions include a vehicle speed being detected as 0, an accelerator input being detected as 0, and a brake pedal being engaged.

16. The vehicle of claim 13, further comprising:
a vehicle speed sensor configured to detect a current speed of the vehicle;
an accelerator pedal having a sensor configured to detect a current engagement amount of the accelerator pedal;
a brake pedal having a sensor configured to detect an engagement amount of the brake pedal; and
an advanced driver assistance system.

17. The vehicle of claim 16, wherein the advanced driver assistance system includes a global positioning system (GPS) configured to detect the current vehicle location and a camera configured to detect the traffic sign.

18. The vehicle of claim 16, further comprising:
an ISG button configured to receive manual input to enable or inhibit the ISG mode of the ISG system.

19. The vehicle of claim 13, wherein the preset location is a location stored in a navigation system.

20. The vehicle of claim 13, wherein the traffic sign is a stop sign, a yield sign, a pedestrian crossing sign, or the like.

21. A system for controlling an idle stop and go (ISG) of a vehicle, comprising:
a memory configured to store program instructions; and
a processor programmed to execute the program instructions, the program instructions when executed configured to:
obtain a current vehicle location;
determine whether the current vehicle location is within a predetermined distance from a preset location or a traffic sign; and
automatically inhibit an ISG mode of the ISG system in response to determining that the current vehicle location is within the predetermined distance from the preset location or the traffic sign.

22. The system of claim 21, wherein the determination of whether the current vehicle location is within the predetermined distance from the preset location or the traffic sign is triggered based on engagement of a brake pedal.

23. The system of claim 21, wherein the preset location is a location stored in a navigation system.

24. The system of claim 21, wherein the current vehicle location is detected using a global positioning system.

25. The method of claim 21, wherein the traffic sign is detected using a camera mounted on the vehicle.
